(19) United States
(12) Patent Application Publication
(10) Pub. No.: US 2011/0086969 A1
(43) Pub. Date: Apr. 14, 2011

(54) FAST DRY POLYESTER LATEX FOR COATINGS

(76) Inventors: Eric Cline, Raleigh, NC (US); Jeffrey Danneman, Raleigh, NC (US); Alan Douglas Roberts, Raleigh, NC (US)

(21) Appl. No.: 12/881,265

(22) Filed: Sep. 14, 2010

Related U.S. Application Data
(60) Provisional application No. 61/250,084, filed on Oct. 9, 2009.

(51) Int. Cl. C08L 75/06

(52) U.S. Cl. 524/507

(57) ABSTRACT

A fast drying latex composition comprising a hydroxyl functional polyester modified with a polyfunctional isocyanate is provided. The modification increases polymer molecular weight by chain extension. Such a fast drying latex composition can be utilized in a coating composition with or without a pigment. The fast drying latex composition does not adversely affect the stability of the polyester latex, and in some situations, may stabilize inherently unstable polyester latexes.

### CROSS-REFERENCE TO RELATED APPLICATIONS

This application claims the benefit of, and incorporates herein by reference in its entirety, the following U.S. Provisional Application: U.S. Provisional Application No. 61/250,084; filed Oct. 9, 2009.

### FIELD AND BACKGROUND OF THE INVENTION

The present invention relates to a fast drying latex composition in emulsion form. Such fast drying latex compositions are useful in a wide variety of coating applications.

Polyester latexes have been used in industry for years as the binder component for both pigmented and non pigmented coatings systems. Solvent-based coatings; however, increasingly do not meet the restrictive environmental targets for reduced volatile organic compounds (VOCs). Thus, the industry has been transitioning away from solvent-based to waterborne systems with a much lower carbon footprint. A common problem with such coatings derived from these latexes; however, is very slow dry time when compared to their solvent-based analogs.

A proposed solution is to accelerate dry rate through the introduction of hydroxyl or epoxy functional groups into the base polymer. This is then blended with a second component such as an isocyanate or amine that will chemically react with the functional groups present in the first component to increase molecular weight. A disadvantage of this approach is that it may require additional formulation at the time of use and the stability of the mixture may be limited by the reaction rate of the functional groups. Additionally, many of the second components such as the isocyanate or amine may have toxicity issues.

Another way to decrease dry time is to introduce carbon-carbon double bonds in the form of C₄-C₂₂ monofunctional carboxylic acids containing one or more ethylene groups which, when mixed with metal driers in the presence of oxygen, react to increase the molecular weight of the polymer. This modification may overcome the stability issues in the two component system if there is no oxygen present. The rate of oxidation, however, is usually insufficient to rapidly overcome the plasticization effects of the surfactant resulting in a coating system that has a dry time far in excess of the same polymer dissolved in solvent.

Thus there continues to be a need for a fast drying waterborne latex composition while avoiding adverse affects on the physical and aesthetic properties of the coating composition in which the waterborne latex composition is used.

### SUMMARY OF THE INVENTION

A fast drying latex composition comprising a hydroxyl functional polyester modified with a polyfunctional isocyanate is provided. The modification increases polymer molecular weight by chain extension. Such a fast drying latex composition can be utilized in a coating composition with or without a pigment. The fast drying latex composition does not adversely affect the stability of the polyester latex, and in some situations, may stabilize inherently unstable polyester latexes.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

All patents, patent applications and publications referred to herein are incorporated by reference in their entirety. In case of a conflict in terminology, the present specification is controlling.

The present invention provides a fast drying latex composition. The composition comprises a hydroxyl functional polyester modified with a polyfunctional isocyanate. The polyfunctional isocyanate may allow for increase in polymer molecular weight, which may raise the glass transition temperature (T_{g}). The one-component system of the present invention may provide sufficient molecular weight to overcome the plasticization effects of the surfactants without destabilizing the latex through a change in particle size or an increase in viscosity. It is noted that the same polymer if reduced in a solvent would exhibit high viscosity or even gel when chain extended with a polyfunctional isocyanate at the same stoichiometry.

The fast drying waterborne latex composition may be utilized in a paint composition which may include a pigment. The fast drying latex composition may also be used as a coating on a substrate. Exemplary coatings may include paints for coating metal, but are not limited to, those commonly identified as architectural coatings, for example, primers, paints, varnish, flat coatings, semi-gloss coatings, gloss coatings, clear coatings, topcoats, stain blocking coatings, penetrating sealers for porous substrates chalky surfaces, concrete, and marble, elastomeric coatings, mastics, caulks, and sealants; industrial coatings, for example, board and paneling coatings, transportation coatings, furniture coatings, and coil coatings; maintenance coatings, for example, bridge and tank coatings and road marking paints; leather coatings and treatments; paper coatings; woven and nonwoven fabric coatings and pigment printing pastes; adhesive coatings, for example, pressure sensitive adhesives and wet- and dry-laminating adhesives; automotive coatings; and ink coatings selectively applied to produce printed images, for example letters and pictures, through techniques such as, for example ink jetting. Exemplary substrates include wood, other cellulosic materials such as paper, metal, plastics, and various composites, and laminates thereof.

As stated above, the fast drying latex composition of the invention comprises a hydroxyl functional polyester. The polyester may comprise a difunctional carboxylic acid and/or anhydride thereof, a diol and/or polyol (i.e., an alcohol having more than two hydroxyl groups), a monofunctional acid, and a natural oil or natural or synthetic fatty acid.

Suitable difunctional carboxylic acids and/or anhydrides may include phthalic anhydride, isophthalic acid, terephthalic acid, glutoric acid, adipic acid, sebacic acid, suberic acid, succinic acid, maleic anhydride, fumaric acid, dimer fatty acids, tetrahydrophthalic anhydride, hexahydrophthalic anhydride, and/or cyclohexane dicarboxylic acid and mixtures thereof. In some embodiments of the invention, the difunctional carboxylic acid is present in the polyester at a concentration in a range of about 5 to about 60 percent by weight, and often is about 18 to about 45 percent by weight.

Suitable diols may include 1,2-ethylene glycol including polymeric ethylene glycol, diethylene glycol, triethylene glycol, tetraethylene glycol, 1,2-propylene glycol, dipropylene glycol, tripropylene glycol, 1,3-propanediol, 1,3-butanediol, 1,4-butanediol, 1,6-hexanediol, neopentyl glycol, 1,4-cyclohexanedimethanol, 1,4-cyclohexanediol, butenediol, butynediol, hydrogenated bisphenols, trimethylpentanediol, 1,8-octanediol and/or tricyclodecanedimethanol, 2,-2-bis(hydroxymethyl)-1,3 propane diol and mixtures thereof. In some embodiments of the invention, the diol is present in the polyester at a concentration in a range of about 0.1 to about 60 percent by weight, and often is about 5 to about 15 percent by weight.

Suitable polyols may include trimethylolpropane, ethoxylated trimethylolpropane, propoxylated trimethylolpropane, propoxylated glycerol, ethoxylated glycerol, glycerol, pentaerythritol, castor oil and/or mixtures thereof trimethylolethane and ethoxylates/propoxylates thereof. In some embodiments of the invention, the polyol is present in the polyester at a concentration in a range of about 5 to about 50 percent by weight, and often is about 15 to about 35 percent by weight.

Suitable monofunctional acids may include benzoic acid, C₈ to C₂₂ fatty acids such as, 2-ethylhexanoic acid, octadecanoic acid, heptadecene carboxylic acid, steroic acid, 1-heptanedecane carboxylic acid, para-t-butylbenzoic acid, etc. In some embodiments of the invention, the monofunctional carboxylic acid is present in the polyester at a concentration in a range of about 0 to about 35 percent by weight.

Suitable natural oils may include but are not limited to soybean oil, palm oil, sunflower seed oil, linseed oil, tung oil, cottonseed oil, and oiticica.

Suitable fatty acids based on naturally occurring fats include but are not limited to safflower fatty acid, soya acid, myristic acid, linseed acid, tall oil fatty acid, rosin acid, coconut fatty acid, sunflower fatty acid, and ricinoleic acid. In some embodiments of the invention, the natural oil and/or fatty acid are present in the polyester at a concentration in a range of about 15 to about 80 percent by weight, and often is about 20 to about 75 percent by weight.

The acid value of the resulting polyester may be in a range of about 0 to about 100 mg KOH per gram. The hydroxyl value of the polyester may be in a range of about 30 to about 180 mg KOH per gram. In one embodiment, the acid value range is about 2 to 15 KOH per gram and the hydroxyl value is about 50 to about 100 KOH per gram.

The other component of the fast drying latex composition is a polyfunctional isocyanate which is used to increase polymer molecular weight by chain extension. The polyfunctional isocyanate may be an aliphatic or aromatic isocyanate and often is a diisocyanate.

Exemplary isocyanates may include trimethylene diisocyanate, tetramethylene diisocyanate, pentamethylene diisocyanate, hexamethylene diisocyanate, 1,5-diisocyanato-2-methylpentane, 1,12-diisocyanatododecane, propylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,2-cyclohexylene diisocyanate, 1,3-phenylene diisocyanate, 1,4-phenylene diisocyanate, 2,4-toluylene diisocyanate, 2,6-toluylene diisocyanate, 4,4′-biphenylene diisocyanate, 1,5-naphthylene diisocyanate, 1,4-naphtylene diisocyanate, 1-isocyanatomethyl-5-isocyanato-1,3,3-trimethylcyclohexane, bis-(4-isocyanatocyclohexyl)methane, 2,2-bis-(4′-isocyanatocyclohexyl)propane, 4,4′-diisocyanatodiphenyl ether, 2,3-bis-(8-isocyanatooctyl)-4-octyl-5-hexylcyclohexene, tetramethylxylylene diisocyanate, isocyanurates of the above diisocyanates and allophanates of the above diisocyanates. Mixtures of these polyisocyanates can likewise be employed. Aliphatic isocyanates, in particular aliphatic diisocyanates, are particularly preferred.

The fast drying latex composition may have a NCO/OH index in a range of about 0.1:1.0 to about 1:0:1:0. The solids content may be in a range of about 30 to about 70 percent. The viscosity range may be about 10 to about 10,000 cps. The particle size range may be from about 30 to about 3000 nm. The T_{g} may range from about −50° to about 100° C. In one embodiment, the range is about −20° to about 50° C.

The fast drying latex composition may include a surfactant system comprising a nonionic surfactant and/or anionic surfactant and/or amphoteric surfactant and/or cationic surfactant. Suitable nonionic surfactants may include polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, and the like, and mixtures thereof. In particular embodiments, the nonionic surfactant is a polyalkylene glycol ether.

Suitable anionic surfactant may include a sodium alkyl aryl sulfonates, alkyl sulphonates, alkylpolyether sulphates, alkyl sulfates, fatty acid soaps, salts of hydrox-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof. The preferred amount is about 1 to about 15 percent by weight. In particular embodiments, the anionic surfactant includes sodium dodecyl benzene sulfonate.

Suitable pigments to be included in a paint composition may include bright pigments such as aluminum powder, copper powder, nickel powder, stainless steel powder, chromium powder, micaceous iron oxide, titanium dioxide-coated mica powder, iron oxide-coated mica powder and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium white, titanium yellow, iron red, carbon black, chrome yellow, iron oxide, various calcined pigments, and others known to those skilled in the art, and mixtures thereof.

The fast drying latex composition may be further modified with an acrylic monomer or a styrene acrylic monomer or oligomer. Such includes either grafting monomer onto the unsaturation of the fatty acid/maleic anhydride adduct or itaconic acid or onto the unsaturation in the fatty acid. The concentration range can be from about 5 to 50 percent by weight. It also may include blending the latex composition with a separately made acrylic or styrene acrylic or vinyl acrylic or ethylene vinyl acetate latex at a concentration level of about 1 to 90 percent by weight. For grafting, the range is about 5 to about 50 percent of the unsaturation, and often is about 5 to about 30 percent by weight.

In other embodiments, the coating composition may optionally include additives such as extenders, rheology modifiers, cosolvents, coalescents, wetting agents, flow/leveling agents, viscosity controlling agents, pH controlling agents, slip resistant agents, mar resistant agents, UV stabilizers, catalysts, drier metals biocides and/or any other adjuvants that are commonly used in waterborne coatings, the selection of which will be within the skill and knowledge of one skilled in the art.

The present invention will now be described in more detail with reference to the following examples. However, these examples are given for the purpose of illustration and are not to be construed as limiting the scope of the invention.

### EXAMPLES

### Example 1

A polyester latex was synthesized from 940 grams of 1-heptadecanecarboxylic acid, 685 grams of benzoic acid, 860 grams of 2,2-bis(hydroxymethyl)-1,3-propane diol and 850 grams of phthalic anhydride. The esterification was done by fusion process at 230° C. and terminated when the acid value reached 10 mg KOH/g and the hydroxyl value reached theoretical value of 100 mg KOH/g. The measured glass transition temperature (T_{g}) of the solid polyester was 7° C.

The polyester was emulsified using a mixture of a non-ionic surfactant consisting of a polyethylene glycol—polypropylene glycol block co-polymer and an anionic surfactant sodium dodecyl benzene sulfonate. 320 grams of the polyester solids were set aside and reduced to final solids of 75% in pentanone solvent prior to emulsification and mixed with the latex surfactants in identical amounts to that found in the latex. The total latex weight was 1750 grams. 580 grams of latex were set aside as a control. 580 grams of latex were chain extended with 30 grams of monomeric 5-isocyanato-1-(isocyanatomethyl)-1,3,3-trimethylcyclohexane at 60° C. over a period of 6 hours.

The 320 grams of polyester and surfactant that was reduced in pentanone was chain extended with 14 grams of monomeric 5-isocyanato-1-(isocyanatomethyl)-1,3,3-trimethylcyclohexane,

TABLE 1
Properties of Polyester Latexes Before
and After Isocyanate Chain Extension

| | Latex 1 | Latex 2 | Latex 3 |
|---|---|---|---|
| Chain Extending | None | 5-isocyanato-1- | 2,4-diisocyanato- |
| Isocyanate | | (isocyanatomethyl)- | 1-methylbenzene |
| | | 1,3,3- | |
| | | trimethylcyclohexane | |
| Final Solids, % | 55 | 55 | 55 |
| Viscosity | 240 cps | 130 cps | 164 cps |
| pH | 7.4 | 6.8 | 6.8 |
| Particle Size, nm | 222 | 228 | 226 |
| Tg, ° C. | −2 | 16 | 21 |
| Theoretical | 107 | 85.5 | 86.1 |
| Hydroxyl Value, | | | |
| mg KOH/g | | | |
| Measured | 106 | 85.1 | 88.9 |
| Hydroxyl Value, | | | |
| mg KOH/g | | | |

TABLE 2
Properties of Polyester and Surfactant Solution
Before and After Isocyanate Chain Extension

| | Solution 1 | Solution 2 |
|---|---|---|
| Chain Extending | None | 5-isocyanato-1-(isocyanatomethyl)- |
| Isocyanate | | 1,3,3-trimethylcyclohexane |
| Final Solids, % | 75 | 75 |
| Viscosity | 23.2 stokes | light gel |
| Tg, ° C. | −3 | 20 |

The data in the above table show that chain extension was achieved without an increase in latex viscosity or a significant change in particle size. Table 2 shows that the same alkyd and surfactant mixture when chain extended in solution result in a large increase in viscosity to the point of being a light gel. Determination of the extent of reaction was accomplished through measurement of the hydroxyl content of the polymer solids before and after chain extension.

Hydroxyl content was measured by water recovering the solid polymer from the latexes. This was accomplished by coating Teflon sheets with both latexes at 15 mil wet thickness and drying the films in an oven at 100° C. for 48 hours. A non-volatiles measurement was done to verify the films were completely dried. The films were re-dissolved in solvent and measured for a change in hydroxyl content. The hydroxyl values are also shown in Table 1 and demonstrate a surprisingly high degree of conversion with both an aliphatic and aromatic isocyanate despite reaction in a water system. The conversion is nearly 100% in both cases. Both latexes also show the presence of urea in FTIR spectra indicating some side reaction did occur. 700 ppm of polyurea was recovered while filtering the latex made from aromatic isocyanate while the aliphatic isocyanate latex filtered cleanly. Both latexes made films that were free of haze.

Glass transition temperature data, also shown in the tables above demonstrate that the glass transition temperature increased upon reaction with isocyanate which results in a faster dry time than unmodified systems which have a lower T_{g}.

### Example 2

A polyester latex is prepared by the reaction of 540 grams of octadecanoic acid, 59 grams of 1,2,3 propane triol, 151 grams bis(hydroxymethyl)-1,3-propane diol, 3 grams 2,5-furandion and 246 grams of phthalic anhydride reacted to an acid value of 6 mg KOH/g and a hydroxyl value of 70 mg KOH/g under fusion conditions at 250° C. The solid polyester is then emulsified in water using a mixture of polyethylene glycol—polypropylene glycol block co-polymer surfactant. The final latex is reduced to 45% solids. The latex is reacted with 50 grams monomeric 5-isocyanato-1-(isocyanatomethyl)-1,3,3-trimethylcyclohexane which is added to the latex over a period of 1 hour at a reaction temperature of 35° C.. The mixture is held for 4 hours at reaction temperature until the isocyanate is completely reacted.

### Example 3

A polyester latex is prepared by the reaction of 463 grams of ricinoleic acid, 48 grams of 1,2,3 propane triol, 176 grams of bis(hydroxymethyl)-1,3-propane diol, 63 grams of benzoic acid and 250 grams of phthalic anhydride reacted to an acid value of 6 mg KOH per gram and a hydroxyl value of 170 mg KOH per grain under fusion conditions at 250° C. The latex from the solid polyester is prepared using a polyethylene glycol—polypropylene glycol block co-polymer surfactant. The latex is reduced to 50% solids and treated with 60 grams of monomeric 1-isocyanato-4-[(4-isocyanatocyclohexyl) methyl] cyclohexane which is added over a period of four hours. The isocyanate is allowed to fully react over a period of 4 hours.

### Example 4

A polyester is prepared by the reaction of 689 grams n-octadecanoic acid, 510 grams benzoic acid, 665 grams 2,2-bis(hydroxymethyl)-1,3-propane diol and 635 grams phthalic anhydride. It is reacted to an acid value of 12 mg KOH/gram and a hydroxyl value of 80 mg KOH/gram at 230° C. The latex from the polyester is prepared by adding 150 grams of a polyethyleneoxide-polypropylene oxide block co-polymer surfactant. The final latex solids is 55%. The latex temperature is adjusted to 60° C. and 175 grams of 5-isocyanato-1-(isocyanatomethyl)-1,3,3-trimethylcyclohexane is added over a period of two hours and allowed to fully react.

### Example 5

A polyester latex was synthesized from 940 grams of 1-heptadecanecarboxylic acid, 685 grams of benzoic acid, 860 grams of 2,2-bis(hydroxymethyl)-1,3-propane diol and 850 grams of phthalic anhydride. The esterification was done by fusion process at 230° C. and terminated when the acid value reached 10 mg KOH/g and the hydroxyl value reached theoretical value of 100 mg KOH/g. The latex was chain extended with 30 grams of monomeric 5-isocyanato-1-(isocyanatomethyl)-1,3,3-trimethylcyclobexane at 60° C. over a period of 6 hours.

### Example 6

High gloss white enamels were formulated with polymers from Example 3 as outlined below in Table 3.

### Example 7

Polymer based on Example 3 without the addition of isocyanate was used and formulated into a white coating as outlined in Table 3.

High gloss white enamels were formulated and produced in the laboratory using adjuncts commonly used in such formulations and via methodology common in the coatings industry as practiced by those skilled in the art. These formulations are given in

TABLE 3

Formulation

| | Comparative | | |
|---|---|---|---|
| | Example 6 | Example 6 | |
| Raw Material | Pounds | Pounds | Gallons |
| Water | 69.70 | 69.70 | 8.37 |
| Natrasol 330 Plus | 1.00 | 1.00 | 0.09 |
| AMP 95 | 0.65 | 0.65 | 0.08 |
| Disperbyk 190 | 12.62 | 12.62 | 1.43 |
| Triton CF 10 | 2.48 | 2.48 | 0.28 |
| Rhodaline 643 | 0.53 | 0.53 | 0.05 |
| Ti-Pure R-900 | 252.35 | 252.35 | 7.58 |
| Polyester without | 509.80 | | 58.06 |
| isocyanate | | | |
| modification | | | |
| Polyester with | | 509.80 | 58.06 |
| isocyanate | | | |
| modification | | | |
| Co 5% Hydrocure II | 2.24 | 2.24 | 0.30 |
| Dri-Rx HF | 0.56 | 0.56 | 0.07 |
| Zr 12% Hydro Cem | 3.50 | 3.50 | 0.43 |
| Propylene Glycol | 8.82 | 8.82 | 1.02 |
| Byk 011 | 1.00 | 1.00 | 0.15 |
| Water | 178.28 | 178.28 | 21.40 |
| Acrysol RM 8W | 6.01 | 6.01 | 0.69 |
| Total | 1049.54 | 1049.54 | 100.00 |

Formulation Physicals

| | |
|---|---|
| Pigment to binder weight ratio | 0.90:1 |
| Pigment volume concentration | 19.6% |
| VOC, g/l | 49.69 |
| Non-Volatile material by weight | 52% |

Films of each formulation were cast on Leneta cards with a Bird applicator of 7 mil gap. This approximates the coverage of brushing, 400 square feet per gallon. The films were allowed to cure at 25° C. and 45% RH. The dry time of these films was assed with a Zapon tack tester using a 500 gram load in accordance with ASTM D 1640.

Example 6 achieved a tack-free state in 8 hours. Comparative Example 6 made with un-modified polymer, failed to reach a tack-free state in 24 hours, at which time testing was discontinued. This data demonstrate the improved cure speed found via the isocyanate modification.

Clear coatings were made with these polymers, water, and drier metals in the ratio shown in the white enamel formulations. Films were cast on glass panels and allowed to air dry for 7 days. Glass transition temperatures, T_{g}, were obtained for these films by methods known to those skilled in the art. The T_{g} for Example 6 is 12° C., that for the Comparative Example 6 is 4° C. This is further evidence of the improvement seen via modification.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed:

1. A fast drying latex composition comprising an aqueous emulsion comprising a hydroxyl functional polyester modified with a polyfunctional isocyanate.

2. A paint or clear coat composition comprising the fast drying latex composition of claim 1 and a pigment.

3. The fast drying latex composition according to claim 1, wherein the hydroxyl functional polyester is derived from a natural oil or natural fatty acid.

4. The fast drying latex composition according to claim 3, wherein the natural oil is selected from the group consisting of soybean oil, palm oil, sunflower seed oil, linseed oil, tung oil, cottonseed oil, and oiticica.

5. The fast drying latex composition according to claim 1, wherein said composition further includes an anionic surfactant and/or a non-ionic surfactant and/or amphoteric surfactant and/or cationic surfactant.

6. The fast drying latex composition according to claim 1, wherein the polyfunctional isocyanate is an aliphatic or aromatic polyfunctional isocyanate.

7. The fast drying latex composition according to claim 1, wherein the acid value of the polyester is in a range of about 0 to about 150 mg KOH per gram,

8. The fast drying latex composition according to claim 1, wherein the hydroxyl value of the polyester is in a range of about 15 to about 180 mg KOH per gram.

9. The fast drying latex composition according to claim 1, wherein the fast drying latex composition has a NCO/OH index in a range of about 0.1:1.0 to about 1.0:1.0.

10. The fast drying latex composition according to claim 1, wherein the fast drying latex composition has a solids content in a range of about 30 to about 70 percent.

11. The fast drying latex composition according to claim 1, wherein the polyester is further modified with acrylic or styrene acrylic monomer or oligomer.

12. A substrate coated with a coating comprising the fast drying latex composition of claim 1.

13. A fast drying latex composition in emulsion form comprising:
a) a hydroxyl functional polyester comprising:
1) 18 to 45 percent by weight of a difunctional carboxylic acid and/or anhydride thereof;
2) 5 to 15 percent by weight of a diol;
3) 5 to 50 percent by weight of a an alcohol having more than two hydroxyl groups;
4) 0 to 35 percent by weight of a monofunctional acid; and
5) 20 to 80 percent by weight of a natural oil and/or natural or synthetic fatty acid; and
b) a polyfunctional isocyanate wherein the polyfunctional isocyanate increases polymer molecular weight by chain extension.

14. A paint composition or clear coat comprising the fast drying latex composition of claim 13 and a pigment.

15. The fast drying latex composition according to claim 13, wherein said composition further includes an anionic surfactant, a non-ionic, a cationic surfactant or an amphoteric surfactant or mixture or blend thereof.

16. The fast drying latex composition according to claim 13, wherein the polyfunctional isocyanate is an aliphatic or aromatic polyfunctional isocyanate.

17. The fast drying latex composition according to claim 13, wherein the acid value of the polyester is in a range from about 0 to about 150 mg KOH per gram.

18. The fast drying latex composition according to claim 13, wherein the hydroxyl value of the polyester is in a range of about 15 to about 800 mg KOH per gram.

19. The fast drying latex composition according to claim 13, wherein the fast drying latex composition has a NCO/OH index in a range of about 0.1:1.0 to about 1.0:1.0.

20. The fast drying latex composition according to claim 13, wherein the fast drying latex composition has a solids content in a range of about 30 to about 70 percent.

21. The fast drying latex composition according to claim 13, wherein the polyester is further modified with acrylic or styrene acrylic monomer or oligomer.

22. A substrate coated with a coating comprising the fast drying latex composition of claim 13.
